(19) United States
(12) Patent Application Publication
(10) Pub. No.: US 2014/0042849 A1
(43) Pub. Date: Feb. 13, 2014

(54) BRUSHLESS MOTOR

(71) Applicant: MINEBEA CO., LTD., Kitasaku-gun (JP)

(72) Inventors: Toshiyuki NISHIKATA, Yonago-shi (JP); Kumio MASUDA, Yonago-shi (JP)

(73) Assignee: MINEBEA CO., LTD., Kitasaku-gun (JP)

(21) Appl. No.: 13/955,698

(22) Filed: Jul. 31, 2013

(30) Foreign Application Priority Data
Aug. 8, 2012 (JP) 2012-176185

(51) Int. Cl. H02K 5/04

(52) U.S. Cl. CPC H02K 5/04
USPC 310/91

(57) ABSTRACT

Reduction in size of a shape of a brushless motor of the outer rotor type having an outer case seen from the axial direction is realized.

The brushless motor has an outer case 101, a rotor frame 107 which has a rotor magnet in an inner circumference thereof, and a shaft 105 which is fixed to the rotor frame 107 and which is held to the outer case 101 in a rotatable condition. The outer case 101 has a shape consisting of curved portions 102a and 102b, and linear portions 102c and 102d, seen from the axial direction.

### TECHNICAL FIELD

The present invention relates to a brushless motor of the outer rotor type.

### BACKGROUND ART

Motors which are used for lens focusing in digital cameras or the like are widely known. The motor for such uses is required to be of reduced size. A motor with a brush is advantageous for reducing size; however, there has been a problem in that noise is generated from the sound of the brush contacting. In particular, since some models of recent digital cameras have functions in which sound can be recorded simultaneously with taking a photograph, generation of the contacting sounds is undesirable. In addition, there has been a problem in that it is difficult to apply high voltage to the motor with a brush. Under such circumstances, a brushless motor (See Japanese Utility Model Publication No. 2532489) is superior since the contacting sound of the brush is not generated and high voltage can be applied easily thereto.

### SUMMARY OF THE INVENTION

A brushless motor of the outer rotor type is advantageous if reduction in size is required, as mentioned above. The reason for this is as follows. First, in an inner rotor structure in which a rotor is formed axially, it is necessary that wire be wound on a salient pole which projects from a circular stator formed outside of the rotor toward a direction of rotation center. However, in the case in which the motor is reduced in size, since gaps between the salient poles become narrow, it may be difficult for a nozzle of a winding machine to enter between the salient poles, and thus the winding operation may become difficult. From this viewpoint, on the other hand, in an outer rotor structure, since a stator is formed inside and salient poles are formed radially, the winding operation is easier compared to the operation in the inner rotor type.

However, in the case of the outer rotor type, since the rotor of outer circumference side rotates, there may be a problem of interference between the rotor and surrounding parts in the case in which the motor is attached in a condition very close to the surrounding parts like in a digital camera. To avoid this problem, it is necessary to cover the outside by a case. However, in the brushless motor of the outer rotor type for which reduction in size is required, this outer case may interrupt reduction in size along circumferential direction. Under such a background, an object of the present invention is to realize reduction in size of shape seen from the axial direction in a brushless motor of outer rotor type having an outer case.

In a first aspect of the invention, a brushless motor has an outer case, a rotor frame which has rotor magnet in an inner circumference thereof and which is arranged in the inside of the outer case in a rotatable condition, a stator core which is fixed to the outer case and which is arranged in a condition having gap at the inside of the rotor frame, and a shaft which is fixed to the rotor frame and which is held to the outer case in a rotatable condition, wherein the outer case has a shape consisting of plural curve portions and plural linear portions, seen from an axial direction.

According to the first aspect of the invention, the shape of the outer case seen from the axial direction includes linear portions, and the size in the radial direction at the portions is shortened. Therefore, reduction in size of the shape seen from the axial direction in the brushless motor of the outer rotor type having the outer case, can be realized.

In a second aspect of the invention, an opening is formed on side portions of the outer case, corresponding to the linear portions of the outer case, in the first aspect of the invention.

In a third aspect of the invention, the brushless motor further comprising an insulator attached on the stator core in order to provide insulation, the insulator holds plural terminal pins which penetrate the insulator along the axial direction and in which one end and the other end of each pin are exposed, a stator coil wound on the stator core is connected to the one end of the terminal pin, and the other end of the terminal pin is connected to a circuit board at the outside, in the first and second aspects of the invention. According to the third aspect of the invention, direct connecting with the circuit board can be performed by the terminal pins.

In a fourth aspect of the invention, the stator core has a structure in which plural salient poles each extending toward a direction apart from an axial center are arranged along the circumferential direction, and the terminal pins penetrate inside of the insulator along the axial direction, at a position of a gap between the mutually adjacent salient poles in the circumferential direction, in the third aspect of the invention. According to the fourth aspect of the invention, since each terminal pin is contained in the gap between the circumferentially adjacent salient poles, size in the radial direction is not increased while having the structure in which the terminal pins penetrate along an axial direction.

In a fifth aspect of the invention, the outer case has a structure in which one side along the axial direction is closed and the other side along the axial direction is open, the shaft is held at the closed side of the outer case in a rotatable condition, a housing for closing the open side of the outer case is attached at the open side of the outer case, and the terminal pins penetrate the housing along the axial direction, in the first to fourth aspects of the invention. According to the fifth aspect of the invention, a strong structure can be obtained.

In a sixth aspect of the invention, the housing has a curve shape portion corresponding to the curve portion of the outer case and a linear shape portion corresponding to the linear portion of the outer case, seen from the axial direction, in the fifth aspect of the invention. According to the sixth aspect of the invention, reduction in size is not inhibited since the housing has a shape fitted to the outer case, seen from the axial direction.

In a seventh aspect of the invention, a projection portion is arranged at an outer circumference of the housing, and a cut portion engaging the projection portion is arranged at the open side portion of the outer case, in the fifth and sixth aspects of the invention. According to seventh aspect of the invention, the outer case and the housing are strongly engaged by the structure in which the projection portion and the cut portion are engaged.

In a eighth aspect of the invention, the projection portion and the cut portion are engaged by rotating the housing against the outer case, in a condition that the housing is fit in the outer case, in the seventh aspect of the invention. According to the eighth aspect of the invention, engaging of the outer case and the housing can be stronger.

In a ninth aspect of the invention, the projection portion and the cut portion are fixed by a swage structure by deforming the cut portion, in a condition that the projection portion and the cut portion are engaged, in the seventh and eighth aspects of the invention. According to the ninth aspect of the invention, engaging of the outer case and the housing can be stronger, since the engaging of the projection portion and the cut portion are fixed by the swage structure.

In a tenth aspect of the invention, clicks projecting to the axial direction are arranged at edge of the axial direction of the outer case, holes through which the clicks penetrate and concave portions which are arranged at a part of the holes of opposite side of a side contacting to the outer case, are arranged at the housing, and the outer case and the housing are engaged by bending the clicks at the inside of the concave portions, in a condition that the clicks penetrate the holes, in the sixth aspect of the invention. According to the tenth aspect of the invention, engaging of the outer case and the housing is fixed by bending the clicks.

In a eleventh aspect of the invention, the housing further comprises a wall portion which extends along the axial direction and contacts to a part of the outer circumference of the outer case from the outside, in the tenth aspect of the invention. According to the eleventh aspect of the invention, deformation of the outer case can be prevented by being pressed from outside by the wall portion.

According to the present invention, reduction in size of the shape of the brushless motor of outer rotor type having the outer case seen from the axial direction, can be realized.

### BRIEF EXPLANATION OF DRAWINGS

FIG. 1A is a perspective view and FIG. 1B is a side view, of the embodiment.

FIG. 2A is a perspective cross-sectional view and FIG. 2B is a cross-sectional view seen from the side, of the embodiment.

FIG. 3 is a perspective view of a portion of the stator and the housing.

FIG. 4A is a perspective view of another embodiment, FIG. 4B is a perspective view of the housing and FIG. 4C is a perspective cross-sectional view of the motor.

### BEST MODE FOR CARRYING OUT THE INVENTION

### Structure

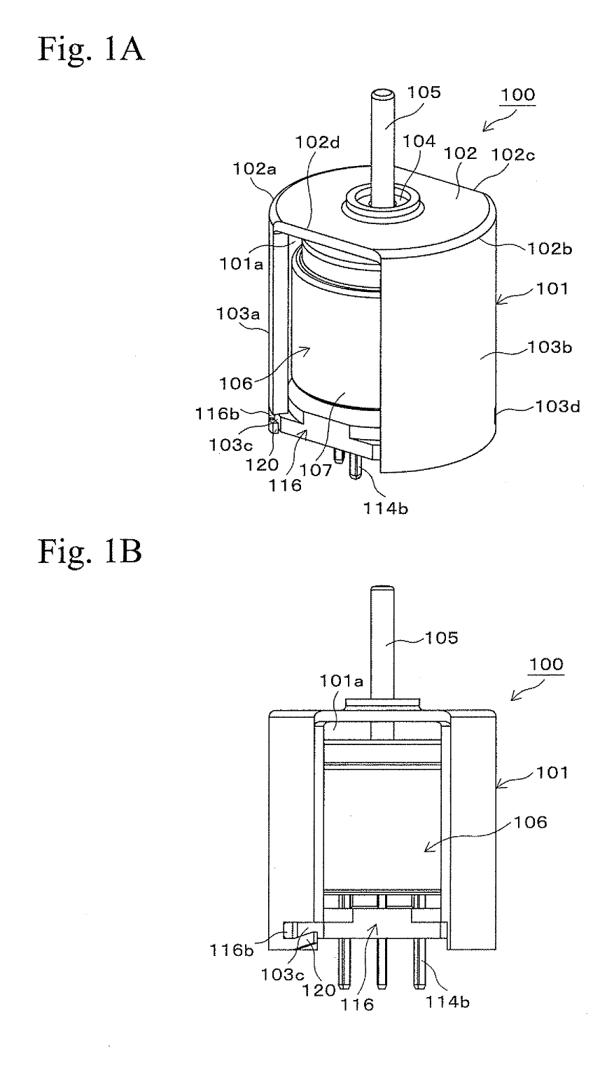

FIG. 1A is the perspective view and FIG. 1B is the side view, of the embodiment. FIG. 1 shows a brushless motor 100 of the embodiment. The brushless motor 100 is a brushless motor of the outer rotor type having an outer case. The brushless motor 100 has the outer case 101. The outer case 101 is made of metal, and has an end surface 102 and curve surface portions 103a and 103b extending from an edge of a curved shape of the end surface 102 along the axial direction. The end surface 102 closes one end (upper end in the figure) of the outer case 101 along the axial direction. The curve surface portions 103a and 103b have a shape constructing part of circular arc having a rotation center as a curvature center, seen from the axial direction.

The end surface 102 has a shape in which both sides of a circular shape are linearly cut, seen from the axial direction. That is, the end surface 102 has curve portions 102a, 102b and mutually parallel linear portions 102c, 102d, seen from the axial direction. In addition, the curve surface portion 103a extends from the curve portion 102a along the axial direction, and the curve surface portion 103b extends from the curve portion 102b along the axial direction. The curve surface portions 103a and 103b are arranged at positions where they are mutually faced, at angular positions of 180 degrees mutually different seen from the axial direction. Two open portions are arranged between the curve surface portions 103a and 103b (only one, 101a, of them is shown in the figure). Upper edges of these two open portions correspond to the linear portions 102c, 102d, respectively. Size of each portion is adjusted so that a rotor 106 mentioned below does not protrude from the two open portions.

A shaft 105 is held at a center of the outer case 101 via a bearing 104 in a rotatable condition. A sliding bearing or a ball bearing can be employed as the bearing 104. The rotor 106 is arranged inside the outer case 101, that is, between the curved surface portions 103a and 103b, in a condition having a gap between the rotor and the case. The rotor 106 is fixed to the shaft 105, and rotates together with the shaft 105 inside of the outer case 101.

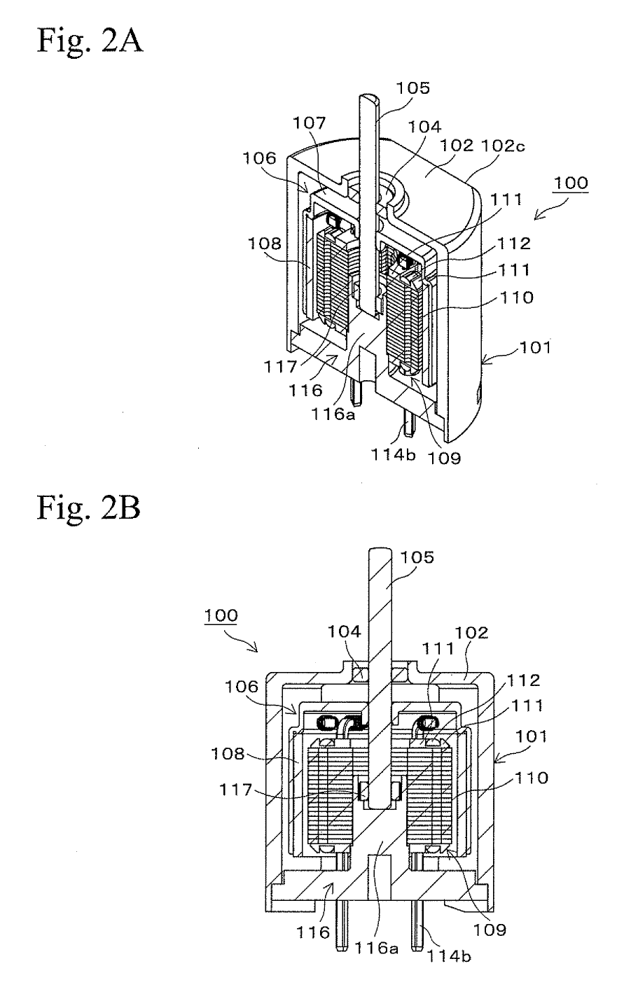

FIG. 2A is a perspective cross-sectional view and FIG. 2B is the cross-sectional view seen from the side, of the embodiment. As shown in FIG. 2, the rotor 106 has a rotor frame 107 which is arranged inside the outer case 101, in a condition having a gap to the outer case 101. The shaft 105 is fixed at a center of an end surface in the axial direction of the rotor frame 107. A rotor magnet 108 is fixed inside of a cylindrical portion of almost cylindrical shape of the rotor frame 107. The rotor magnet 108 has a thin cylindrical shape and is magnetized in a condition such that polarities are mutually applied NS, NS, . . . along the circumferential direction.

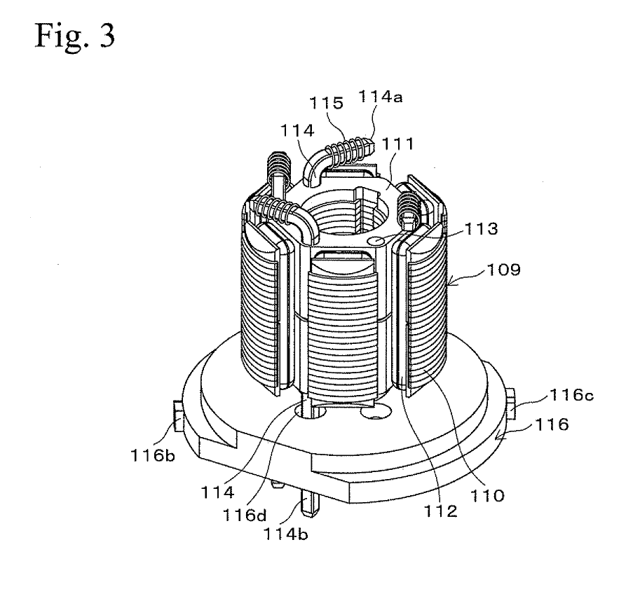

A stator core 109 is arranged inside of the rotor magnet 108, in a condition having a gap to the rotor magnet. The stator core 109 consists of multiple layered tabular magnetic materials such as magnetic steel sheets. FIG. 3 is the perspective view of the portions of the stator and the housing. As shown in FIG. 3, the stator core 109 extends in a direction apart from the rotation center (axial center), and salient poles 110 are arranged along the circumferential direction. Each of the salient poles 110 has an extending portion which extends in a direction apart from the rotation center and a tip portion which is a tip of the salient pole and which opens like an umbrella shape seen from the axial direction. An insulator 111 consisting of an insulating body (such as resin) is attached to the stator core 109. The insulator 111 prevents magnet wire and the stator core 109 of a stator coil 112 from being short-circuited. The magnet wire is wound to the extending portion of the salient pole 110 via the insulator 111, thus constructing the stator coil 112.

In this embodiment, the insulator 111 has a structure which can be divided along the axial direction, and the divided bodies are attached on the stator core 109 from front and back of the axial direction. It should be noted that the insulator 111 and the stator core 109 can be formed unitarily, by the injection molding method using the stator core 109 as an insert material. It should be noted that the expression “the insulator 111 is attached on the stator core 109” includes both a case in which the insulator 111 of finished article or semifinished article is attached on the stator core 109, and a case in which the insulator 111 and the stator core 109 are formed being unified by the injection molding method using the stator core 109 as an insert material.

As shown in FIG. 3, plural through holes 113 are arranged in the insulator 111. The plural through holes 113 extend along the axial direction, and metallic terminal pins 114 are inserted therein. Each of the terminal pins 114 penetrates the insulator 111 along the axial direction, and the both ends thereof protrude from the insulator 111. One end portion 114a of the terminal pin 114 penetrating the insulator 111 protrudes in an upper direction in the figure (a direction to which the shaft 105 protrudes), an end portion of the wire constructing the stator coil 112 is wound and connected to the protruded part, and then the protruded part is bent. The other end portion 114b of the terminal pin 114 is inserted in a through hole 116d formed in a resin-made housing 116, and the tip thereof protrudes to the outside of the housing. A part of the terminal pin 114 protruding to the outside of the housing 116 (a part of reference numeral 114b) is inserted in a contact hole arranged in a wiring pattern of a circuit board, which is not shown in the figure, and is fixed therein by soldering. In this embodiment, four terminal pins are arranged. Three systems of driving current, each system consisting of two stator coils 112 arranged at positions facing each other across the axial center, is supplied to these four terminal pins 114 (one of them is a common terminal). The terminal pins 114 are inserted to the insulator 111 above; however, the insulator 111 and the terminal pins 114 can be formed being unified by the injection molding method using the terminal pins 114 as an insert material. In this case, since all that needs to be done is to simply attach the insulator 111 in which the terminal pins 114 are beforehand included to the stator core 109, workability is increased.

The stator core 109 has a hollow structure extending along the axial direction, the projection portion 116a of the housing 116 engages this hollow part, and thus, the stator core 109 and the housing 116 are engaged. In addition, the shaft 105 is held to the projection portion 116a via a bearing 117, in a rotatable condition.

In addition, the housing is engaged to the outer case 101 by a structure explained as follows. As shown in FIG. 3, projection portions 116b and 116c are arranged on an outer edge of the housing 116. A cut portion 103c is arranged in the outer case 101 in a condition of extending along the circumferential direction. As shown in FIG. 1, the projection portion 116b engages the cut portion 103c. Furthermore, a cut piece 120 is formed by formation of the cut portion 103c, and by bending the cut piece 120 to the inner axial direction, a swage structure which fixes the engagement relationship of the cut portion 103c and the projection portion 116b can be obtained. Although it is not obvious from the figure, the projection portion 116c also engages a cut portion 103d of the outer case 101 by a similar structure.

Furthermore, in the structure shown in FIG. 1, a shape of the housing 116 seen from the axial direction is similar to that of the end surface 102 of the outer case 101, and edge of the housing 116 does not protrude from the edge of linear portions 102c and 102d of the end surface 102 of the outer case 101, seen from the axial direction.

The other end portion 114b of the terminal pin 114 is fixed to the circuit board (not shown) by soldering. That is, a dedicated IC is installed on the circuit board (not shown), and a contact hole is open on a circuit pattern of the board. The other end portion 114b of the terminal pin 114 is inserted to this contact hole and soldered to the circuit pattern so as to connect the terminal pin 114. This circuit board (not shown) has a circuit in which inverse voltage generated in the motor side is detected thereby detecting a rotation position of the rotor 106, and a driving circuit in which rotation of the rotor 106 is controlled by the PWM method or the PAM method depending on the information of rotation position of the rotor 106 detected by the above circuit, installed thereon.

### Assembling Procedure

Hereinafter an example of a procedure for assembling the brushless motor 100 is explained. First, the stator side is assembled. First, the stator core 109 is formed by layered steel plates (core). Next, the resin-made insulator 111 is covered on the stator core 109 (they can be integrally molded), and the terminal pins 114 are press fitted in the through holes 113. FIG. 3 shows a situation in which four terminal pins 114 are attached. Subsequently, the magnet wire is wound to each of the salient poles 110 of the stator core 109 insulated by the insulator 111, thereby forming the stator coil 112. In this case, an end portion of the magnet wire constructing the stator coil 112 is wound and connected to one end part 114a of each of terminal pins 114, and then the connected portion is soldered. Soldering can be performed by immersing in a soldering dipping vessel, or by soldering individually using a soldering iron. Alternatively, the terminal pin 114 can be fixed to the magnet wire by resistance welding or laser welding.

Next, the connected portion of the terminal pin 114 is bent to a certain direction. In this case, the connected portion may contact with the rotor frame 107 if bent too much to the outside, and the connected portion may contact to the shaft 105 if bent too much to the axis inside. Therefore, the terminal pin 114 is bent to an intermediate position of these. Thus the assembled body of the stator is obtained, and it is press fitted in the housing 116. This situation is shown in FIG. 3. In this condition, the projection portion 116a of the housing 116 is press fitted into a through hole fowled at the axial center part of the stator core 109, thereby engaging the stator core 109 and the housing 116. Here, the through holes 116d through which the terminal pins 114 penetrate are arranged in the housing 116, and the diameter of these through holes 116 is designed so as to have sufficient clearance to the terminal pin. After the situation shown in FIG. 3 is completed, the bearing 117 is arranged inside of the projection portion 116a of the housing 116.

Next, the rotor 106 is assembled. The rotor 106 consists of the rotor frame 107, the ring-shape rotor magnet 108 fixed on the inner circumferential surface of the frame, and the shaft 105 fixed to the rotor frame 107. After the rotor 106 is completed, preparing the member of the stator side shown in FIG. 3 mentioned above, and then, the lower end of the shaft 105 of the rotor 106 is inserted in the bearing 117 attached on the projection portion 116a of the housing 116. Thus, the semifinished product, in which the rotor 106 is attached to the stator side, is obtained.

On the other hand, a member in which the bearing 104 is attached to the outer case 101 is prepared, and the upper end of the shaft 105 of the above-mentioned semifinished product is put through the bearing 104 from inside of the outer case 101. In this case, with a condition in which positions around the axis of the housing 116 and the outer case 101 are mutually displaced, the housing 116 is relatively moved against the outer case 101 along the axial direction so that positions along the axial direction of the cut portion 103c and the projection portion 116b are aligned. Next, the housing 116 is relatively rotated against the outer case 101, so that the cut portion 103c and the projection portion 116b are engaged. Then, as shown in FIG. 1B, the cut piece 120 is bent to the axial direction to obtain the swage structure, that is, a structure in which engagement of the cut portion 103c and the projection portion 116b would not be broken. In this situation, the shaft 105 is held at both ends, and thus the brushless motor 100 is completed.

The brushless motor 100, for example, can be attached to a circuit board by using the four terminal pins 114. Here, the circuit board is a so-called printed board, on which a dedicated IC having a function driving the brushless motor 100 and a function detecting rotation of the shaft 105 depending on inverse voltage, or another circuit is installed, and on which wiring pattern to the terminal pins 114 has contact holes thereon. The four terminal pins 114 are inserted in the contact holes of the circuit board and then soldered, so as to unify the brushless motor 100 and the circuit board.

### Example of Driving

Once driving current is supplied to the terminal pins 114, magnetic attractive force and magnetic repulsive force are generated between the salient poles of the stator core 109 and the magnetic poles of the rotor magnet 108, thereby generating a force rotating the rotor 106. Here, by switching direction of exciting current applied to the terminal pins 114, an action which makes the rotor 106 rotate is generated continuously, thereby rotating the rotor 106. Then, rotation of the rotor 106 propagates to the shaft 105 via the rotor frame 107, thereby rotating the shaft 105.

### Superiority

The brushless motor 100 can be used instead of a conventional small motor having brush. Since the brushless motor 100 can be driven at a higher voltage compared to the motor with brush, high properties can be obtained despite its small size. In addition, there is no contact with a brush, and a motor having low noise activity can be obtained.

Furthermore, since the brushless motor 100 has the outer case 101, it can be set into an apparatus easily, and interference between parts inside of the apparatus and the rotor 106 can be prevented. In addition, since it has the shape in which both sides of the outer case 101 are cut seen from the axial direction, the shape seen from the axial direction can be reduced in size, and a structure appropriate for setting the motor in a narrow space can be obtained.

Since the terminal pins 114 are set in the insulator 111 and that each terminal pin 114 penetrates space between the mutually neighboring salient poles 110, reduction in size can be realized despite its structure including terminal pins. Furthermore, the structure in which the terminal pins 114 are assembled in the insulator 111 can facilitate a process for production, thus high property for assembling can be obtained. Since the terminal pins 114 protrude along the axial direction and the terminal pins 114 are assembled and fixed in the insulator 111 in the structure shown in the figure, it is easy for the terminal pins 114 to be fixed to the circuit board directly, thereby providing a strong structure.

Since the motor of the present invention has the structure in which the housing 116 is rotated against the outer case 101 thereby engaging them, a strong engaging structure in which no adhesive is needed can be obtained by a simple assembly work.

### Other

The open portions 101a at a side surface of the outer case in FIG. 1 are not limited to two positions, and open parts can be formed at plural positions, in even number, such as at four or six positions. In the case in which four open parts are formed, an almost square shape in which there are four linear portions seen from the axial direction and in which corner parts each connecting these four linear edges is formed by a curve, can be obtained. In this case, the shape of the outer case seen from the axial direction can be shortened along vertical and horizontal directions. Alternatively, a structure in which this open part 101a is closed by a tabular member can be employed. In this case, the rotor 106 is in a condition of being sealed. This structure can be obtained by performing a drawing processing to the outer case 101, for example. In the sealed condition, dust or the like can be prevented from entering inside the outer case. Alternatively, the open portion 101a can be formed by both an open portion and a closed portion. In FIG. 1B, although an example is shown, in which the cut piece 120 is deformed along the axial direction to deform the cut portion 103c thereby obtaining a swage structure, another swage structure can be obtained by deforming the cut piece 120 to the direction of the axial center. Alternatively, another swage structure can be obtained by deforming the cut piece 120 along the axial direction and the direction of axial center, that is, in a perspective direction.

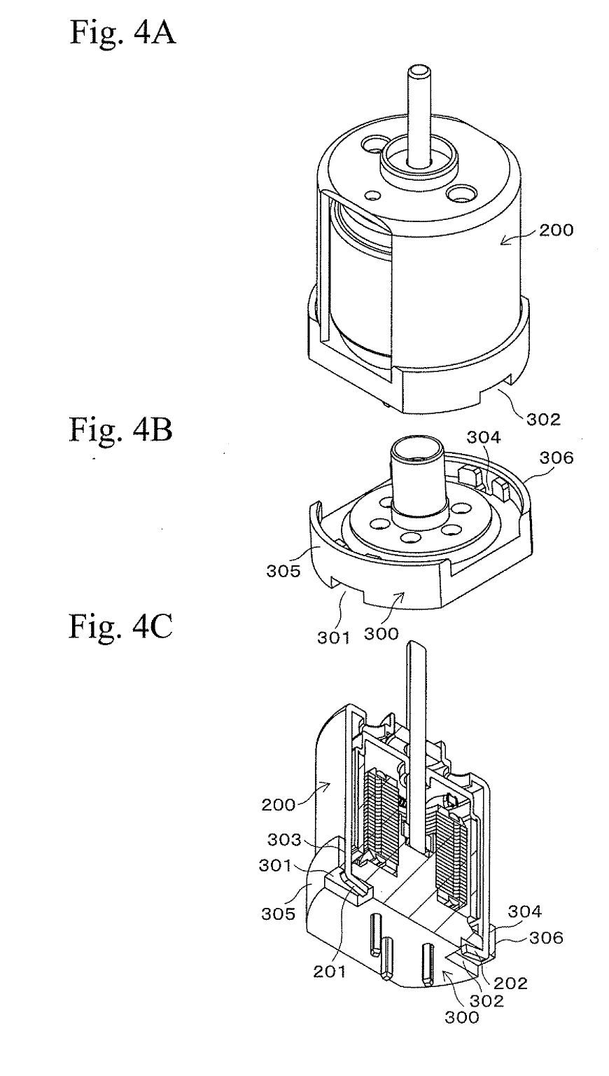

FIG. 4 shows another embodiment. FIG. 4A shows the perspective view of the embodiment, FIG. 4B shows the perspective view of the housing, and FIG. 4C shows the perspective cross-sectional view. In the case of this example, the structure is different from that shown in FIGS. 1 to 3. Hereinafter, parts of the structure which are different from the structure shown in FIGS. 1 to 3 are explained. In the structure shown in FIG. 4, clicks 201 and 202, which protrude from the edge part of the lower end of the axial direction of the outer case 200 along the axial direction, are arranged. A housing 300 has concave portions 301, 302, holes 303, 304, and wall portions 305, 306.

In this structure, the outer case 200 and the housing 300 are engageed in the following steps. First, in a condition in which the clicks 201 and 202 are straight, positions of the click 201 and the hole 303, and positions of the click 202 and the hole 304 are aligned, the outer case 200 and the housing 300 are made closer to each other along the axial direction, and they are contacted with each other. In this case, they are contacted so that the outer case 200 is inserted inside the wall portions 305, 306. Furthermore, in this case, the click 201 is inserted in the hole 303, and the click 202 is inserted in the hole 304.

At the step the edge of the outer case 200 and the housing 300 are contacted, the click 201 is bent to the direction of rotation center inside of the concave part 301, and the click 202 is bent to the direction of rotation center inside of the concave part 302, thereby obtaining the situation shown in FIG. 4C. In this situation, the click 201 engages the bottom part of the concave portion 301 and the click 202 engages the bottom part of the concave portion 302, thereby engaging the outer case 200 and the housing 300.

The scope of the present invention is not limited to each of the embodiments described above, and the present invention includes any modification that those skilled in the art can conceive, and the effect of the invention is not also limited in the above-mentioned scope. That is, various additions, modifications, and partial omissions can be made to the invention without departing from the scope and spirit of the present invention.

The present invention can be applied to a brushless motor of the outer rotor type.

### EXPLANATION OF REFERENCE NUMERAL

100 . . . brushless motor, 101 . . . outer case, 102 . . . end surface of the outer case, 102a . . . linear portion, 102b . . . curve portion, 102c . . . linear portion, 102d . . . curve portion, 103a . . . curve surface portion, 103b . . . curve surface portion, 103c . . . cut portion, 103d . . . cut portion, 104 . . . bearing, 105 . . . shaft, 106 . . . rotor, 107 . . . rotor frame, 108 . . . rotor magnet, 109 . . . stator core, 110 . . . salient pole, 111 . . . insulator, 112 . . . stator coil, 113 . . . through hole, 114 . . . terminal pin, 114a . . . one end portion of the terminal pin, 114b . . . the other end portion of the terminal pin, 116 . . . housing, 116a . . . projection portion, 116b . . . projection portion, 116c . . . projection portion, 116d . . . through hole, 117 . . . bearing, 120 . . . cut piece, 200 . . . outer case, 201 . . . click, 202 . . . click, 300 . . . housing, 301 . . . concave portion, 302 . . . concave portion, 303 . . . hole, 304 . . . hole, 305 . . . wall portion, 306 . . . wall portion.

1. A brushless motor comprising:
an outer case,
a rotor frame which has a rotor magnet in an inner circumference thereof and which is arranged in the inside of the outer case in a rotatable condition,
a stator core which is fixed to the outer case and which is arranged in a condition having a gap against inside of the rotor frame, and
a shaft which is fixed to the rotor frame and which is held to the outer case in a rotatable condition,
wherein the outer case has a shape consisting of plural curve portions and plural linear portions, seen from an axial direction.

2. The brushless motor according to claim 1, wherein an opening is formed at side portions of the outer case, corresponding to the linear portions of the outer case.

3. The brushless motor according to claim 1, wherein the brushless motor further comprising an insulator attached on the stator core in order to provide insulation,
the insulator holds plural terminal pins which penetrate the insulator along the axial direction and in which one end and the other end of each pin are exposed,
a stator coil wound on the stator core is connected to the one end of the terminal pin, and
the other end of the terminal pin is connected to a circuit board at the outside.

4. The brushless motor according to claim 3, wherein the stator core has a structure in which multiple salient poles, each extending toward a direction apart from an axial center, are arranged along the circumferential direction, and
the terminal pins penetrate inside of the insulator along the axial direction, at a position of a gap between the mutually adjacent salient poles in the circumferential direction.

5. The brushless motor according to claim 1, wherein the outer case has a structure in which one side along the axial direction is closed and the other side along the axial direction is open,
the shaft is held at the closed side of the outer case in a rotatable condition,
a housing for closing the open side of the outer case is attached at the open side of the outer case, and
the terminal pins penetrate the housing along the axial direction.

6. The brushless motor according to claim 5, wherein the housing has a curved shape portion corresponding to the curved portion of the outer case and a linear shape portion corresponding to the linear portion of the outer case, seen from the axial direction.

7. The brushless motor according to claim 5, wherein a projection portion is arranged at an outer circumference of the housing, and
a cut portion engaging the projection portion is arranged at the open side portion of the outer case.

8. The brushless motor according to claim 7, wherein the projection portion and the cut portion are engaged by rotating the housing against the outer case, in a condition in which the housing is fit in the outer case.

9. The brushless motor according to claim 7, wherein the projection portion and the cut portion are fixed by a swage structure by deforming the cut portion, in a condition in which the projection portion and the cut portion are engaged.

10. The brushless motor according to claim 6, wherein clicks projecting along the axial direction are arranged at edge of the axial direction of the outer case,
holes through which the clicks penetrate and concave portions which are arranged at a part of the holes of opposite side of a side contacting to the outer case, are arranged at the housing, and
the outer case and the housing are engaged by bending the clicks at the inside of the concave portions, in a condition in which the clicks penetrate the holes.

11. The brushless motor according to claim 10, wherein the housing further comprises a wall portion which extends along the axial direction and contacts a part of the outer circumference of the outer case from the outside.
